(19) United States
(12) Patent Application Publication
(10) Pub. No.: US 2026/0071076 A1
(43) Pub. Date: Mar. 12, 2026

(54) CEMENTITIOUS COOLING PAINT AND CEMENTITIOUS COOLING CONSTRUCTION MATERIAL

(71) Applicant: Nanyang Technological University, Singapore (SG)

(72) Inventors: Hong LI, Singapore (SG); Jipeng FEI, Singapore (SG)

(21) Appl. No.: 19/104,905

(22) PCT Filed: Sep. 21, 2023
(86) PCT No.: PCT/SG2023/050640

§ 371 Date: Feb. 19, 2025

(30) Foreign Application Priority Data
Sep. 21, 2022 (SG) 10202251097A
Sep. 30, 2022 (SG) 10202251226B

(51) Int. Cl. C09D 1/08; C09D 5/33; C09D 7/61; C09D 7/63; C09D 7/65

(52) U.S. Cl. CPC C09D 1/08; C09D 5/004; C09D 7/61; C09D 7/63; C09D 7/65

(57) ABSTRACT

A cementitious cooling paint is provided. The cementitious cooling paint comprises a composite cement; a structural filler; a water-absorbing polymer; a water capture material; and water wherein the water to composite cement ratio is from 0.4 to 1.2 by mass; the composite cement to structural filler ratio is from 0.4 to 0.7 by mass; the composite cement to water-absorbing polymer ratio is from 0.01 to 0.03 by mass; and the composite cement to water capture material ratio is from 0.05 to 0.3. The cementitious cooling paint may further include a dispersant, wherein the composite cement to dispersant ratio is from 20 to 50 by mass. A cementitious cooling construction material and a cement-based building product comprising the cementitious cooling construction material are also provided.

### CROSS-REFERENCE TO RELATED APPLICATION

This application claims the benefit of priorities to the Singapore patent application no. 10202251097A filed 21 Sep. 2022 and Singapore patent application no. 10202251226B filed 30 Sep. 2022, the contents of which are hereby incorporated by reference in its entirety for all purposes.

### TECHNICAL FIELD

This application relates to a cementitious cooling paint and a cementitious cooling construction material. In particular, the application relates to a cementitious cooling paint and a cementitious cooling construction material that exhibit dual passive cooling approaches including radiative cooling and evaporative cooling.

### BACKGROUND

Passive radiative cooling technology is a novel approach for continuous energy-saving surficial cooling. Such a cooling outcome requires cooler to exhibit ultrahigh thermal emissivity within atmospheric window (8-13 μm). In hot seasons, solar power density could vary from 800-1200 W/m² in different region, and such a high solar intensity is unfavourable for outdoor cooling. Thus, high solar reflection is as important as long-wavelength infrared (LWIR) emission for continuous passive cooling. However, such a coating fabrication usually involves organic solvents for its robust structural or adhesive properties, which is not environmentally friendly. Most importantly, the performance of passive radiative cooling paint is highly dependent on the ambient conditions such as relative humidity, where high relative humidity significantly weaken the cooling effect. Moreover, the performances of radiative cooler which rely heavily on the radiation angle, vary significantly on the applied surface, thus hindering its applicable potential.

Conventional coatings for buildings are mainly used for protective (with good mechanical strength) and decoration purposes (with smooth surface and various colors). Some commercial cooling paints are typically in very white color for strong solar reflection but such paints have poor passive radiative cooling capability due to their low thermal emissivity within atmospheric window. However, neutral white color paint is restricted for most building coating application as it can cause light pollution under strong sunlight, especially for building sidewall. Due to the fundamental limitations from its working principle, radiative cooler always suffers from restricted cooling performance for sidewall application due to insufficient radiation angle to sky.

As for construction materials, they are mainly made from cement with sands for both low cost and good mechanical property consideration. The traditional concrete shows a dark color that is usually solar absorptive, and thus most buildings require a layer of sunlight reflection coating above the concrete surface to reduce solar heating. However, due to the upper limit of the reflection of building surface (to reduce light pollution), typically less than 85%, substantial amount of solar energy still heats up the surface which leads to unsatisfactory cooling. Tropical countries have high ambient temperature, high relative humidity, and intensive solar radiation (up to 1200 W/m²). Such countries have high active energy consumption as the use of air-conditioning for indoor cooling has greatly increased over the past decades.

Besides radiative cooling, water evaporation is another passive process that continuously consumes thermal energy. Evaporative cooling by water spraying or equivalent method has been applied in accident Egypt. However, long-lasting and water efficient evaporative cooling necessitates a media that can accommodate large amount of water. To this end, a hydrogel type of coating has recently been developed for evaporative cooling since it shows extremely high water content. However, its poor mechanical properties in terms of loading bearing and scratch-resistance limited its potential in the construction industry.

It is therefore desirable to provide a cementitious cooling paint and a cementitious cooling construction material that seek to address at least one of the problems described hereinabove, or at least to provide an alternative.

### SUMMARY

According to a first aspect of the present disclosure, a cementitious cooling paint is provided. The cementitious cooling paint comprises a composite cement; a structural filler; a water-absorbing polymer; a water capture material; and water; wherein the water to composite cement ratio is from 0.4 to 1.2 by mass; the composite cement to structural filler ratio is from 0.4 to 0.7 by mass; the composite cement to water-absorbing polymer ratio is from 0.01 to 0.03 by mass; and the composite cement to water capture material ratio is from 0.05 to 0.3 by mass.

In some embodiments, the cementitious cooling paint further comprises a dispersant, wherein the composite cement to dispersant ratio is from 20 to 50 by mass.

According to a second aspect of the present disclosure, a cementitious cooling construction material is provided. The cementitious cooling construction material comprises a composite cement; a structural filler; a water-absorbing polymer; a water capture material; dispersant and water; wherein the water to the composite cement ratio is from 0.5 to 1.5 by mass; the composite cement to structural filler ratio is from 0.4 to 0.7 by mass; the composite cement to water-absorbing polymer ratio is from 0.01 to 0.03 by mass; the composite cement to water capture material ratio is from 0.05 to 0.3 by mass; and the composite cement to dispersant ratio is from 8 to 15 by mass.

In some embodiments, the cementitious cooling construction material further comprises alkaline water for hydrating the cementitious cooling construction material and for preventing the cementitious cooling construction material from cracking.

According to a third aspect of the present disclosure, a cement-based building product comprising the cementitious cooling construction material of the present disclosure is provided. In some embodiments, the cement-based building product is one selected from cooling tile, cooling brick, cooling concrete, cooling concrete block, cooling concrete slab and cooling cement wall.

According to a fourth aspect of the present disclosure, a kit of parts containing a cementitious cooling paint as defined in the present disclosure is provided. The kit of parts comprises a first portion containing a solid mixture consisting of a composite cement and a structural filler; and a second portion containing a liquid mixture consisting of a water-absorbing polymer, a water capture material, a dispersant and water; wherein the water to the composite cement ratio is from 0.4 to 1.2 by mass; the composite cement to structural filler ratio is from 0.4 to 0.7 by mass; the composite cement to water-absorbing polymer ratio is from 0.01 to 0.03 by mass; the composite cement to water capture material ratio is from 0.05 to 0.3 by mass; and the composite cement to dispersant is from 20 to 50 by mass.

In a further aspect of the present disclosure, a method for producing a cement-based building product comprising the cementitious cooling construction material of the present disclosure is provided. The method comprises preparing a solid mixture by mixing a composite cement with a structural filler; preparing a liquid mixture by mixing water-absorbing polymer together with a water capture material, a dispersant; and water; mixing the solid mixture and the liquid mixture homogenously to form a cementitious cooling construction material precursor; hydrating the cementitious cooling construction material precursor using alkaline water to prevent cracks in the cementitious cooling construction material precursor; and moulding the hydrated cementitious cooling construction material precursor into the desired cement-based building product.

In some embodiments, the water to composite cement ratio is from 0.5 to 1.5 by mass; the composite cement to structural filler ratio is from 0.4 to 0.7 by mass; the composite cement to water-absorbing polymer ratio is from 0.01 to 0.03 by mass; the composite cement to water capture material ratio is from 0.05 to 0.3 by mass; and the composite cement to dispersant ratio is from 8 to 15 by mass.

### BRIEF DESCRIPTION OF THE DRAWINGS

Various embodiments of the present disclosure are described hereinbelow in the detailed description with reference to the following drawings:

FIG. 1 is a schematic illustration of the components of a cementitious cooling paint in accordance with some embodiments of the present disclosure.

FIG. 2 is a schematic illustration of the working mechanism of a cementitious cooling paint when applied onto a surface of a construction material.

FIG. 3A is a graph illustrating the accumulated water ratio of two approaches during rain (liquid gathering) and sunlight-free time (vapor gathering).

FIG. 3B is a graph illustrating a TGA curve, showing the overall water storage and its thermal stability of the cementitious cooling paint of the present disclosure.

FIG. 3C shows the results of pore volume test and visualization test whereby the inset is a micro-CT scanning image.

FIG. 3D shows a differential scanning calorimeter (DSC) curve of the evaporative performance of the cementitious cooling paint.

FIG. 4A is a SEM image of CCP-30 showing C—S—H porous structure (average pore diameter of 1 μm) and surficial bonded nanoparticles (average diameter of 350 nm).

FIG. 4B shows a homogeneous interface between the cured paste of the cementitious cooling paint and a cement-fiber substrate.

FIG. 5A to 5C are graphs illustrating the optical performance of CCP-30 of FIG. 4A. FIG. 5A shows a solar reflectance spectrum of CCP-30 under dry and wet states (water wetted). FIG. 5B shows a Mie scattering efficiency of nanoparticles with varied diameters within solar range. Particles with diameter of about 350 nm exhibit broadest (300-1500 nm) scattering performance within high solar energy range. FIG. 5C is a plot showing the scattering efficiency change of porous structure (D=1 μm) under wet (water) and dry states.

FIG. 5D is a plot showing the scattering efficiency change of nanoparticle (D=350 μm) under wet (water) and dry states.

FIG. 5E is a plot showing the water absorptive range solar reflectance reduction of CCP-30 upon wetting, which only accounts for about 2.5% of total solar energy.

FIG. 5F is a plot showing the total solar reflectance changes along increased doping ratio under dry and wet states. Nanoparticle doping increases both dry and wet reflectance, while the larger increasing slope of wet state corresponds to theoretical scattering performance that sufficient nanoparticle occupation leads to less scattering reduction upon water filling.

FIG. 5G is a plot showing the emissivity spectrum within atmospheric window, indicating good radiative cooling feature of CCP-30, which is partially contributed by additives.

FIG. 5H are SEM images of pure C—S—H matrix curing without and with PVA additive. The obvious morphology difference shows that PVA wraps outside C—S—H matrix, leading to higher structural integrity. Simultaneous wrapping during hydration leads to a strong hydrogen bonding network, which helps to maintain sustainable water for cement particles to generate well connected C—S—H matrix.

FIG. 6 is a schematic illustration of a cementitious cooling paint applied onto a portion of the surface of a brick, with the brick placed onto a concrete.

FIGS. 7A and 7B show the temperature difference at outdoor condition of a brick with a portion coated with the cementitious cooling paint after stabilization for 2 hours (solar intensity of about 800 W/m²; relative humidity of about 65%; Tair of about 35° C.). FIG. 7A is an optical image of the cementitious cooling paint 602 on a portion of the concrete brick 604.

FIG. 7B is an IR image showing the temperature difference under direct sunlight between the brick 604 and the portion of the brick 602 coated with the cementitious cooling paint.

FIGS. 8A, 8B and 8C are graphs illustrating the optical features of samples for small scale cooling test and related spectrums. FIG. 8A is a graph showing the total solar reflectance and atmospheric window range thermal emittance of the three samples. Noted that CCP-30 has little reflectance variation upon wetting, an error bar is taken to show the range. It is worth noting that CCP-30 has similar thermal emittance with BSRCP (BaSO₄ radiative cooler), while the solar reflectance is about 4% lower. The lower temperature with lower solar reflectivity proves the effectiveness of evaporative cooling feature enabled by designed structure. FIG. 8B shows the solar reflectance spectrum of the three samples. FIG. 8C shows the thermal emittance spectrum of the three samples.

FIG. 9 is a graph showing a typical cloudy day cooling performance of the different samples, with recording started from static state. Temperature profile shows the best sub-ambient cooling performance exhibited by CCP-30, where the evaporative cooling contributes to the slower heating under sunlight.

FIG. 10 is a graph showing a typical sunny day cooling performance of the different samples. CCP-30 exhibits stable temperature once put under sunlight and the slowest temperature increasement under rising sunlight in the morning, which are contributed by the evaporation of water inside.

FIG. 11 is a group showing the results of (a) cooling test carried out in California; (b) cooling test carried out in Chang Chun. Stable cooling performances under various climates indicates universal applicability of CCP-30.

FIG. 12A show the optical images of three demo houses with different paints, namely, cementitious cooling paint (CCP), commercial-RC paint (CRCP) and normal white paint (NWP).

FIG. 12B are graphs illustrating the long time cooling performance of the different paints for the demo houses, the delay of temperature peaks originates from thermal insulation effect of the construction material.

FIG. 12C is an IR image showing contrastive surficial temperatures around 4pm as pointed, where CCP-30 surface is about 2° C. cooler than other paints. The IR camera was calibrated indoor according to CCP-30 surface temperature before imaging.

FIG. 13A is an optical image showing three livable size concrete houses where an electricity saving test was carried out, where commercial white paint, commercial radiative cooling paint and CCP-30 were painted for comparison. Same series air-con systems and independent electricity meters were installed in the houses. Target room temperatures were set at 260C, each test lasts for 3 days.

FIG. 13B shows the 3-day electricity consumption data recorded by electricity meters under different weather conditions.

FIG. 14 is an image showing a setup prepared for temperature comparison of different concrete bricks under direct sunlight (about 1000 W/m²). The image was taken after a 2-hour stabilization.

FIG. 15A and FIG. 15B are graphs illustrating the temperature profiles of different samples of concretes taken during weak-sunlight time of day. FIG. 15A is a graph showing the recorded temperatures of the different samples. FIG. 15B is a graph showing the corresponding ambient conditions including solar intensity and relative humidity (RH).

FIG. 16A and FIG. 16B are graphs illustrating the temperature profiles of different samples of concretes taken during daytime under test. FIG. 16A is a graph showing the recorded temperatures of the different samples. FIG. 16B is a graph showing the corresponding ambient conditions including solar intensity and relative humidity (RH).

FIG. 17A and FIG. 17B are graphs illustrating the results obtained from the weather accelerating robustness test. FIG. 17A is a graph showing a programmed chamber condition of two cycles. FIG. 17B is a graph showing the solar reflectance before and after 50 cyclic tests.

FIG. 18 is a graph showing the results of an abrasion test (1.25 kg Load with H-10 abrader) conducted between CCP-30 and C-B. The results prove that water-absorbing polymer (PVA) and water capture material (LiCl) ensure to form stronger C—S—H matrix.

FIG. 19 is a schematic illustration of lower effective water to cement (W/C) ratio resulted in compact cement powder distribution within CCP-30 paste. Image (a) shows an initial pure cement 191 in powder form with large gap 192. Image (b) shows a hydrated C—S—H 193 with weak C—S—H matrix after undergoing full hydration 194. Image (c) shows an initial CCP 195 in powder form with small gap 196 and BaSO₄ nanoparticles 197. Image (d) shows a hydrated C—S—H of CCP 198 with strong C—S—H matrix after undergoing partial hydration 199.

FIG. 20 is a mechanism illustration of water evaporation induced structural difference. Image (a) shows a C-B with crack 201, plastic shrinkage 202 and fast water loss 203 after water evaporation. Image (b) shows a CCP with uniform structure 204, negligible plastic shrinkage 205 and slow water loss 206 after water evaporation.

FIG. 21 shows Raman spectrums of C-B-30 and CCP-30, confirming formation of C—S—H matrix and different state of hydration.

FIG. 22 is a mechanism illustration of C—S—H matrix difference affected by additive induced water evaporation speed change. Image (a) shows an initiate condition of cement powder comprising BaSO₄ nanoparticles 221 with water. Image (b) shows cement powder cured with a polymeric additive (CCP-30). The image shows water channel 222, strong C—S—H network 223 and slow water loss 224; and Image (c) shows a cement power cured without additive (C-B). The image shows weak C—S—H network 225 and fast water loss 226.

FIG. 23 shows TEM images and related spotting EDS elemental spectrum showing more homogenous matrix in CCP-30 with same curing time, which corresponds to the different hydration state revealed by contrastive Ca/Si ratio.

FIG. 24 shows TEM images and related point EDS spectrum on particle surfaces in C-B and CCP-30 sample.

FIG. 25 shows optical images of CCP-30 on commercial oil-based wall sealer surface 251, water-based wall sealer surface 252 and concrete surface 253. The good adhesion to sealers promises broad application potential for constructions.

FIG. 26 is a graph showing the results obtained for the optical performance of CCP-30 under 500h (50 cycles) weather accelerating test. The results show that CCP-30 has good anti-degradation property.

FIG. 27 is a graph showing optical performance comparison between CCP-30 and commercial-RC under a 3-month outdoor exposure test. Commercial-RC shows an obvious reduction in solar range while CCP-30 remains stable, indicating excellent anti-weather and anti-contamination features.

FIG. 28 is a plot illustrating the powder mixing sequence effect on optical performance. The comparable optical performance with different sequences ensures that the commonly accepted all-in-one method is applicable for preparing CCP-30 paste.

FIG. 29 is a plot showing coloring comparison between CCP-30 and commercial-RC for evaluation of visual effect. With comparable visible reflectance and color factors (x and y), CCP-30 exhibits dimmer surface that is favored for visual comfort under sunlight.

FIG. 30 is a plot showing the results of standardized corrosion test of CCP-30 on bare R-Con. The results indicate CCP-30's suitability for bare construction.

FIG. 31A and FIG. 31B illustrate the coloring feature of CP-30 compared to public used commercial radiative cooling paint. FIG. 31A illustrates L*a*b space coloring factors, showing CCP-30 with less bright feature but comparable color preference. FIG. 31B shows the results of a whiteness test. The results indicate CCP-30 exhibits a dimer surface than commercial reflective paint.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any, and all combinations of one or more of the associated listed items.

As used herein, “comprising” means including, but not limited to, whatever follows the word “comprising”. Thus, use of the term “comprising” indicates that the listed elements are required or mandatory, but that other elements are optional and may or may not be present.

As used herein, “consisting of” means including, and limited to, whatever follows the phrase “consisting of”. Thus, use of the phrase “consisting of” indicates that the listed elements are required or mandatory, and that no other elements may be present.

A detailed description of various embodiments will be described below with reference to the drawings.

The present disclosure relates to a cementitious cooling paint and a cementitious cooling construction material. The cementitious cooling paint and the cementitious cooling construction material both exhibit dual passive cooling approaches including radiative cooling and evaporative cooling. At nighttime, the cementitious cooling paint and the cementitious cooling construction material capture water vapour from the surrounding air automatically and store it within the concrete structure of a building or the cooling construction material's porous structure, respectively, thereby completing water replenishment process. At daytime, the stored water evaporates to achieve evaporative cooling under strong sunshine. These approaches greatly enhance passive cooling capability of buildings when the cementitious cooling paint is applied directly onto the building surfaces or when the buildings are constructed using the cementitious cooling construction material of the present disclosure. Furthermore, the cementitious cooling paint and the cementitious cooling construction material are prepared using commercial cement materials such as Portland cement or geopolymer cement which have similar physical and chemical properties as commercial concretes, and thus has strong affinity to construction surfaces as well as primer coatings.

In one aspect, the present disclosure provides a cementitious cooling paint comprising a composite cement, a structural filler, a water-absorbing polymer, a water capture material and water. The water and the composite cement are in a predetermined ratio for forming slurry with suitable viscosity, depending on the method of application of the cementitious cooling paint onto suitable surfaces.

In some embodiments, the water to composite cement ratio is from 0.4 to 1.2 by mass.

In some embodiments, the composite cement to structural filler ratio is from 0.4 to 0.7 by mass.

In some embodiments, the composite cement to water-absorbing polymer ratio is from 0.01 to 0.03 by mass.

In some embodiments, the composite cement to water capture material ratio is from 0.05 to 0.3 by mass. In other embodiments, the ratio ranging from 0.05 to 0.2, and yet in other embodiments, the ratio ranging from 0.1 to 0.3 by mass.

In some embodiments, the composite cement is at least one selected from various types and grades of Portland cements and geopolymer cements.

In some embodiments, the structural filler is at least one selected from the group consisting of silicon dioxide (SiO₂), barium sulfate (BaSO₄), calcium carbonate (CaCO₃), zinc oxide (ZnO), aluminium oxide (Al₂O₃), zirconium dioxide (ZrO₂), titanium dioxide (TiO₂), iron(III) oxide (Fe₂O3), hydrated goethite (α-FeOOH), Prussian Blue, and other solar reflective nanomaterials. The structural filler comprises nanoparticles having an average particle size ranging from 0.3 Ξm to 2 μm, depending on specific optical request.

In some embodiments, the water-absorbing polymer is at least one selected from the group consisting of sodium poly(acrylate), sodium carboxymethyl cellulose, sodium alginate, polyvinyl alcohol, hydroxypropyl methylcellulose, carboxymethyl cellulose and other hydrated polymeric material for water storage.

In some embodiments, the water capture material is at least one selected from the group consisting of deliquescent salts such as lithium chloride (LiCl) and calcium chloride (CaCl₂), and hydroscopic polymeric materials. The water capture material is imbedded for efficient water replenishment at nighttime when humidity is high and temperature of the surrounding air is low (without sunlight).

In some embodiments, the cementitious cooling paint further comprises a dispersant. The dispersant is at least one selected from the group consisting of sodium polyacrylic and superplasticizer such as sulfonated naphthalene formaldehyde condensate, sulfonated melamine formaldehyde condensate, acetone formaldehyde condensate and polycarboxylates ether. In some embodiments, the superplasticizer is used for reducing water demand from the concrete. The superplasticizer can be added to the cementitious cooling paint during the manufacturing process or it can be added and mixed with the cementitious cooling paint before use.

In some embodiments, the ratio of composite cement to dispersant is from 20 to 50 by mass. In some embodiments, the cementitious cooling paint is provided in a slurry or semi-liquid form for use as a cooling paint for application onto appropriate surfaces. In other embodiments, the cementitious cooling paint may be provided in the form of a liquid, powder or gas for further processing into appropriate form for use as a coating for application onto appropriate surfaces.

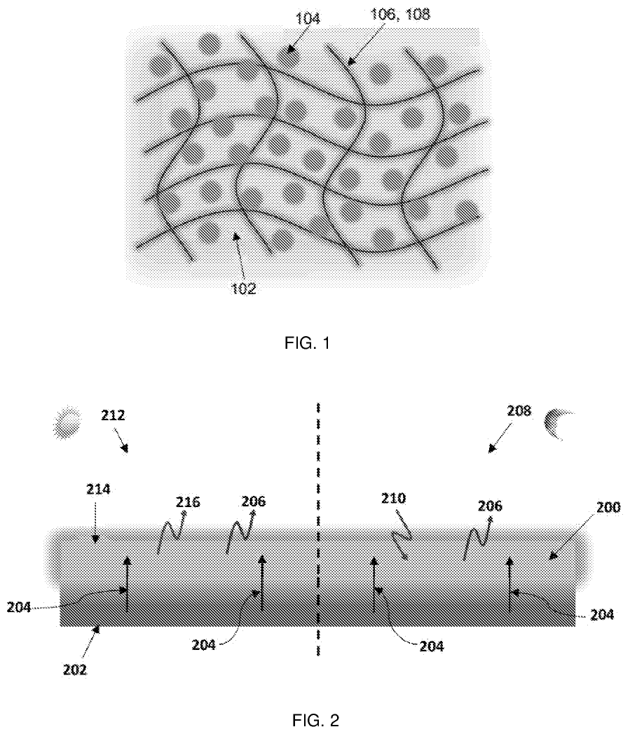

FIG. 1 is a schematic illustration of the various components contained in the cementitious cooling paint. The composite cement matrix 102 provides mechanical robustness and stable porous structure, inside which the nanomaterial structural filler 104 occupies the space for efficient light scattering and thus reflectance increasement, as well as enhancing the mechanical strength of the cementitious cooling paint. The porous structure allows water vapour to diffuse into the composite cement matrix 102 to be absorbed by the water capture material 106, which is then extracted by the highly hydrated water-absorbing polymer matrix 108 for storage. The water-absorbing polymer matrix acts as a micro water container within the porous structure for long-lasting cooling effect. Besides, the structural filler 104 possesses strong thermal emissivity within atmospheric window, thus providing efficient radiative cooling. With the determined ratios of the components contained in the cementitious cooling paint, the cementitious cooling paint and the construction material coated with the cementitious cooling paint exhibit high mechanical robustness, sufficient water absorption at nighttime, efficient water evaporation under sunlight, suitable solar reflectance (of about 85%), and sustainable passive cooling.

FIG. 2 shows an arrangement with a layer of cementitious cooling paint 200 applied onto a construction surface 202. The arrows 204 show the direction of heat conduction within the construction surface 202 and arrows 206 show the direction of long-wavelength infrared (LWIR) radiation. At nighttime 208, ambient temperature and thermal radiation decreases while humidity increases. Water absorption 210 from ambient air by water capture material occurs. At this moment, evaporation is much less than absorption, leading to water storage within the concrete matrix of the construction surface 202. At daytime 212, intensive sunlight and high ambient temperature 214 continuously stimulate water evaporation 216, while the water absorption rate becomes lower or negligible, resulting in cooling performance. At the same time, high thermal emission through atmospheric window continuously radiates energy into the outer ambient air and thus achieving passive radiative cooling.

The cementitious cooling paint of the present disclosure possess two possible approaches to gather water from ambient air: (i) through water absorption; and (ii) capillary diffusion.

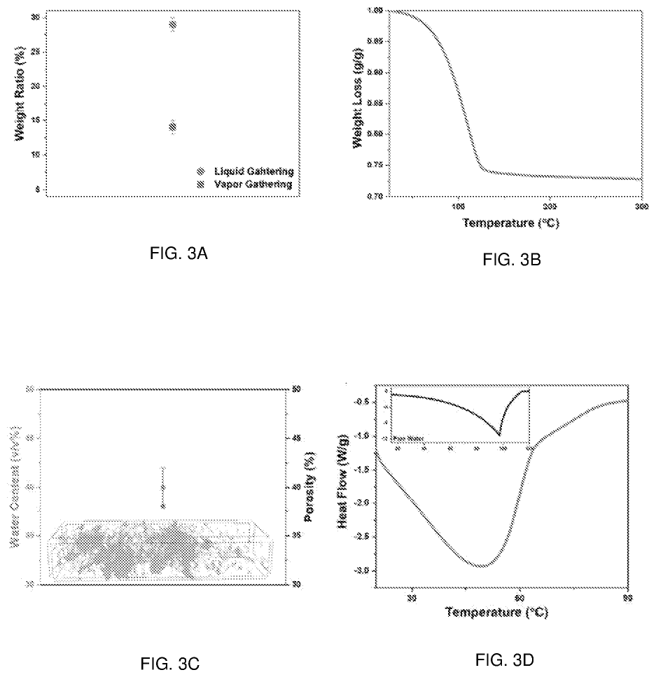

FIG. 3A shows the water gathering capability of a cured cementitious cooling paint. The porous structure could accumulate water through the capillary diffusion under a simulated rain condition, resulting in about 30% wt water storage inside to be utilized for evaporative cooling, while the water vapor gathering from air under real nighttime condition results in about 15% water accumulation (about 27° C., 75% RH). Beyond the water capturing feature, it should be emphasized that a negligible swelling feature allows a stable cycling of the absorption-desorption processes. This is most important for constructional purposes, and because of the the stable C—S—H gel matrix, the cured cementitious cooling paint is able to keep the porous structure within the composite cement matrix stable during the cycling process which is promising for long-term usage.

The TGA curve, FIG. 3B fits well with the water accumulation result shown in FIG. 3A, suggesting that the cured cementitious cooling paint can store about 30% wt of water inside for evaporative cooling. Besides, the cementitious cooling paint exhibits excellent thermal stability at extreme temperature compared to common water-abundant materials like hydrogel. This broadens the applicable potential of the cementitious cooling paint. Furthermore, micro-CT scanning reveals rich porous structure inside the cured cementitious cooling paint with an estimation pore volume of about 38%v/v. This fits well with the water volume evaluated by sorbing-drying test. The results in FIG. 3C shows that a high porosity within a robust matrix formed from a paint-type slurry is obtained. Moreover, evaporation behavior comparison between pure water and soaked cementitious cooling paint was also carried out the and results are as shown in FIG. 3D. Unlike the sharp peak obtained by pure water, water within the cementitious cooling paint has a smooth heat absorption curve starting from low temperature. This reveals a favoured thermal consumption feature contributed by the porous structure under normal air temperature range.

In various embodiments, the cementitious cooling paint is prepared by mixing the composite cement, the structural filler, the water-absorbing polymer, the water capture material, the dispersant and water together in appropriate ratios. The mixing can be carried out in any sequence, depending on application situation. In some embodiments, the water-absorbing polymer, the water capture material, and water are pre-mixed as liquid form, while the composite cement and the structural filler are pre-mixed as solid form. The liquid mixture and the solid mixture are then homogenously mixed to form a cementitious cooling paint precursor or a cementitious cooling paint depending on the amount of water used in the process of preparing the cementitious cooling paint. In some embodiments, the cementitious cooling paint precursor is further mixed with water and/or a dispersant in appropriate amount and blended to form a slurry with high viscosity suitable for use as a paint. The amounts of the different components in the cementitious cooling paint allow slurry with high viscosity to be formed and this makes the slurry easy to be applied onto suitable surfaces and materials, including onto construction sidewall with desired thickness. The strong affinity between the cementitious cooling paint and the commercial concrete leads to formation of Calcium Silicates Hydrates (C—S—H) gel interface. This leads to ultra-strong adhesion of the cementitious cooling paint to the applied concrete surfaces. The slurry exhibits fast curing/hardening feature, preventing it from potential damage during curing.

In a second aspect, a cementitious cooling construction material is provided. The cementitious cooling construction material comprises a composite cement; a structural filler; a water-absorbing polymer; a water capture material; dispersant and water; wherein the water to the composite cement ratio is from 0.5 to 1.5 by mass; the composite cement to structural filler ratio is from 0.4 to 0.7 by mass; the composite cement to water-absorbing polymer ratio is from 0.01 to 0.03 by mass; the composite cement to water capture material ratio is from 0.05 to 0.3 by mass; and the composite cement to dispersant ratio is from 8 to 15 by mass.

The cementitious cooling construction material further comprises alkaline water for hydrating the cementitious cooling construction material and preventing the cementitious cooling construction material from cracking.

In some embodiments, the composite cement is at least one selected from various types and grades of Portland cements and geopolymer cements.

In some embodiments, the structural filler is at least one selected from the group consisting of silicon dioxide (SiO₂), barium sulfate (BaSO₄), calcium carbonate (CaCO₃), zinc oxide (ZnO), aluminium oxide (Al₂O3), zirconium dioxide (ZrO₂), titanium dioxide (TiO₂), iron(III) oxide (Fe₂O3), hydrated goethite (α-FeOOH), Prussian Blue, and other solar reflective nanomaterials. The structural filler comprises nanoparticles having an average particle size ranging from 0.3 μm to 2 μm, depending on specific optical request.

In some embodiments, the water-absorbing polymer is at least one selected from the group consisting of sodium poly(acrylate), sodium carboxymethyl cellulose, sodium alginate, polyvinyl alcohol, hydroxypropyl methylcellulose, carboxymethyl cellulose and other hydrated polymeric material for water storage.

In some embodiments, the water capture material is at least one selected from the group consisting of deliquescent salts such as lithium chloride (LiCl) and calcium chloride (CaCl₂), and hydroscopic polymeric materials. The water capture material is imbedded for efficient water replenishment at nighttime when humidity is high and temperature of the surrounding air is low (without sunlight).

In some embodiments, the dispersant is at least one selected from the group consisting of sodium polyacrylic and superplasticizer such as sulfonated naphthalene formaldehyde condensate, sulfonated melamine formaldehyde condensate, acetone formaldehyde condensate and polycarboxylates ether. In some embodiments, the superplasticizer is used for reducing water demand from the concrete. The superplasticizer can be added to the cementitious cooling construction material during the manufacturing process or it can be added and mixed with the cementitious cooling construction material before use.

In some embodiments, the cementitious cooling construction material has a viscosity suitable for fabricating cement-based building products including, but are not limited to, cooling tile, cooling brick, cooling concrete, cooling concrete block, cooling concrete slab and cooling cement wall.

In some embodiments, the cementitious cooling construction material is prepared in a similar manner as the cementitious cooling paint except that in order for the cementitious cooling construction material to be used in fabricating the cement-based building products, the cementitious precursor in slurry form is hydrated before the slurry is used for moulding into suitable shapes for making the cement-based building products. In some embodiments, the cementitious precursor is hydrated by spraying alkaline water at intervals for maintaining higher mechanical strength in the cementitious cooling construction material and for preventing cracks in the cementitious cooling construction material. In some embodiments, the alkaline water is sprayed once every 1 to 2 days in an amount sufficient to keep the cementitious cooling construction material sufficiently hydrated before and during the moulding process. In some embodiments, the cementitious precursor of the construction material for use in fabricating the cement-based building products has a viscosity lower than the cementitious cooling paint precursor to facilitate easier flow of the cementitious precursor during the moulding process. Any suitable moulding process and conditions may be employed for producing the cement-based building products using the cementitious cooling construction material without departing from the scope of the present disclosure.

In a third aspect, a cement-based building product comprising the cementitious cooling construction material of the present disclosure is provided. In some embodiments, the cement-based building product is one selected from cooling tile, cooling brick, cooling concrete, cooling concrete block, cooling concrete slab and cooling cement wall.

In a fourth aspect, a kit of parts containing a cementitious cooling paint of the present disclosure as defined hereinabove is provided. The kit of parts comprising a first portion containing a solid mixture consisting of a composite cement and a structural filler; and a second portion containing a liquid mixture consisting of a water-absorbing polymer, a water capture material, a dispersant and water; wherein the water to the composite cement ratio is from 0.4 to 1.2 by mass; the composite cement to structural filler ratio is from 0.4 to 0.7 by mass; the composite cement to water-absorbing polymer ratio is from 0.01 to 0.03 by mass; the composite cement to water capture material ratio is from 0.05 to 0.3 by mass; and the composite cement to dispersant ratio is from 20 to 50 by mass.

In some embodiments, the cementitious cooling paint from the kit of parts is prepared by mixing the first portion containing the solid mixture and the second portion containing the liquid mixture together and blending the two portions to obtain the cementitious cooling paint. In other embodiments, the cementitious cooling paint is prepared by mixing the first portion containing the solid mixture and the second portion containing the liquid mixture with water in predetermined amount and blending the mixture to obtain the cementitious cooling paint with suitable viscosity for application of the cementitious cooling paint onto suitable surfaces.

In a further aspect, a method for producing a cement-based building product comprising the cementitious cooling construction material of the present disclosure is provided. The method comprises preparing a solid mixture by mixing a composite cement with a structural filler; preparing a liquid mixture by mixing water-absorbing polymer together with a water capture material, a dispersant; and water; mixing the solid mixture and the liquid mixture homogenously to form a cementitious cooling construction material precursor; hydrating the cementitious cooling construction material precursor using alkaline water to prevent cracking of the cementitious cooling construction material precursor; and moulding the hydrated cementitious cooling construction material precursor into the desired cement-based building product. In some embodiments, the water to composite cement ratio is from 0.5 to 1.5 by mass; the composite cement to structural filler ratio is from 0.4 to 0.7 by mass; the composite cement to water-absorbing polymer ratio is from 0.01 to 0.03 by mass; the composite cement to water capture material ratio is from 0.05 to 0.3 by mass; and the composite cement to dispersant ratio is from 8 to 15 by mass.

In some embodiments, the cementitious cooling construction material precursor is hydrated at intervals in an amount sufficient to keep the cementitous cooling construction material sufficiently hydrated before and during the moulding process. In some embodiments, the alkaline water is sprayed once every 1 to 2 days. Other frequencies may be employed without departing from the scope of the present disclosure. Any suitable moulding process and conditions may be employed for producing the cement-based building products using the cementitious cooling construction material without departing from the scope of the present disclosure. In some embodiments, the cement-based building product is one selected from cooling tile, cooling brick, cooling concrete, cooling concrete block, cooling concrete slab and cooling cement wall.

The cementitious cooling paint of the present disclosure exhibits several advantages. First, the cementitious cooling paint is an efficient heat isolation layer due to the presence of water in the layer as it has the ability to absorb water vapour from ambient air. Secondly, the cementitious cooling paint is a combination of a radiative cooler through thermal radiation (within atmospheric window) and an evaporative cooler due to water evaporation. Thirdly, the cementitious cooling paint has a lower solar reflectance and this avoids light pollution, which is a drawback of neutral white radiative cooler. The cementitious cooling paint offers cooling even when it is applied to sidewalls of outdoor and indoor surfaces. This is not achievable in some cooling paints known in the state of the art which cooling is weakened on sidewalls due to insufficient radiation angle. The cementitious cooling paint of the present disclosure allows thickness control when the cementitious cooling paint is applied over a surface. The cementitious cooling paint has strong affinity and it is fast curing. The construction material coated with the cementitious cooling paint shows up to 12° C. lower temperature than conventional construction material under intensive sunlight (about 800 W/m²), showing great cooling outcome.

The cementitious cooling paint and the cementitious cooling construction material are cost-effective cement-based composite which meets the industrial requirements. The cementitious cooling paint can be prepared by simply mixing the various components to form the cementitious cooling paint, by mixing the cementitious cooling paint with water and/or superplasticizer additive, or by simply mixing the solid mixture and the liquid mixture together with water to form the cementitious cooling paint. Similarly, the cementitious cooling construction material can be prepared by simply mixing the various components to form the cementitious cooling construction material, by mixing the cementitious cooling construction material with water to obtain the desired viscosity, or by simply mixing the solid mixture and the liquid mixture together with water to form the cementitious cooling construction material for use in fabricating other cement-based building products. The simple fabrication procedures based on common commercialized materials endows them cost-effective and environment-friendly, with excellent scalability.

The cementitious cooling paint can be applied to construction materials such as tiles, bricks, concrete, concrete block, concrete slab, cement wall, etc. For use in construction industry. The cementitious cooling paint can be applied for use in construction of rooftop for passive cooling and heat insulation purposes. The cementitious cooling paint can provide moderate reflective coating for construction of sidewalls cooling purpose. It can be applied to concrete wall for repair and reinforcement purposes. It can also be used as other outdoor cooling coating, such as water tank coating and cold-chain vehicle painting. It can also be used as a maritime paint to avoid heating and energy consumption. The cementitious cooling construction material can be used for fabricating cement-based building products with cooling effects including, but are not limited to, cooling tile, cooling brick, cooling concrete block, cooling concrete slab, cooling cement wall, and cooling concrete as pavement material.

To facilitate a better understanding of the invention, the following examples of specific embodiments are given. In no way should the following examples be read to limit or define the entire scope of the invention. One skilled in the art will recognize that the examples set out hereinbelow are not an exhaustive list of the embodiments of this invention.

### EXAMPLES

### Materials

The raw material of cooling paint sample includes White Cement (AALBORG 52.5N), Polyvinyl Alcohol (Mw˜13000, Sigma Aldrich), BaSO₄ nanoparticle (A22 industrial product, Hico Novel Materials) and Lithium Chloride (Sigma Aldrich). All materials were bought to use without further treatments.

### Example 1—Preparation of Cementitious Cooling Paint and Other Comparative Examples

Firstly, 10% wt polyvinyl alcohol (PVA) solution was prepared by dissolving PVA powder in deionised water at 60° C. In this example, three types of materials were prepared, which are cementitious cooling paint (CCP), cement-BaSO₄ paint (C-B), and Pure Cement.

A cementitious cooling paint (CCP) precursor containing cement (10 g), barium sulfate (BaSO₄) (10-30 g), 10%wt PVA (5 mL) and lithium chloride (LiCl) (1 g) and deionised water (15 mL) was prepared. The sample is named CCP-30, which refers to a CCP with 30 g of BaSO₄.

Before preparation, 1 g of LiCl was dissolved in 5 mL deionised water at room temperature to avoid clustering effect to form a solution A. Cement powder and BaSO₄ were uniformly mixed in a 250 ml beaker to break clusters formed during storage. Then, 15 mL 10% wt PVA solution was slowly poured into the mixed powder with continuous stirring. After 5 min stirring, 5 mL of solution A was added, with continuous stirring lasting for another 10 minutes.

A C-B sample containing cement, BaSO₄, LiCl and deinoised water was prepared. The sample is named C-B-30, which refers to a C-B with 30 g of BaSO₄. The precursor preparation of C-B was same with CCP except that addition of 15 mL 10% wt PVA solution was replaced with 15 mL deionised water.

A pure cement sample containing only cement and deionised water was prepared. After mixing the cement powder with water, the solution was put into silicone mold for curing.

### Example 2—Preparation of Cementitious Cooling Construction Material

The cementitious cooling construction material was prepared by pre-mixing a cement powder with BaSO₄ to form a solid mixture, and pre-mixing 10% wt PVA with LiCl (1 g), deionised water (15 mL), and a dispersant to form a liquid mixture. The liquid mixture and the solid mixture were then homogenously mixed to generate a cementitious cooling construction material in slurry form.

For fabricating a cement-based building product, the slurry with desired viscosity was hydrated before the slurry was fed into a mould and during moulding. During hydration, alkaline water was frequently (1 time/1-2 days) sprayed for maintaining higher mechanical strength and to avoid cracking in the cementitious cooling construction material.

### Example 3

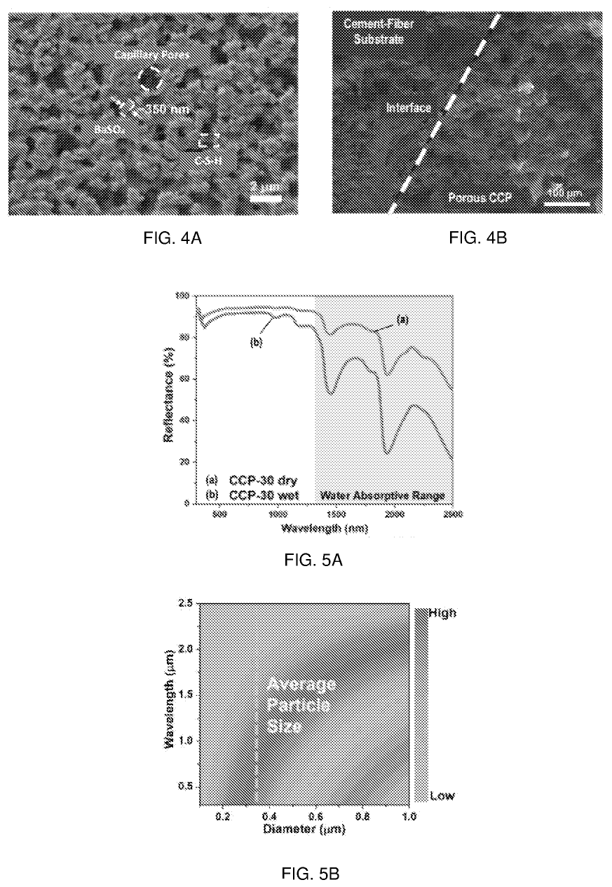

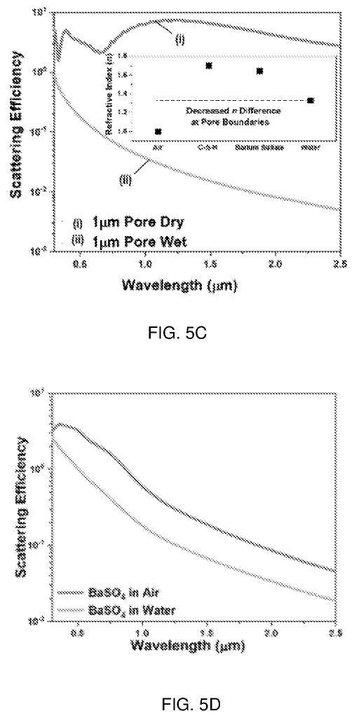

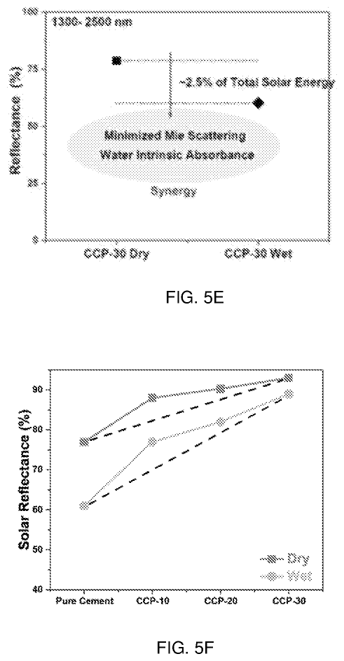

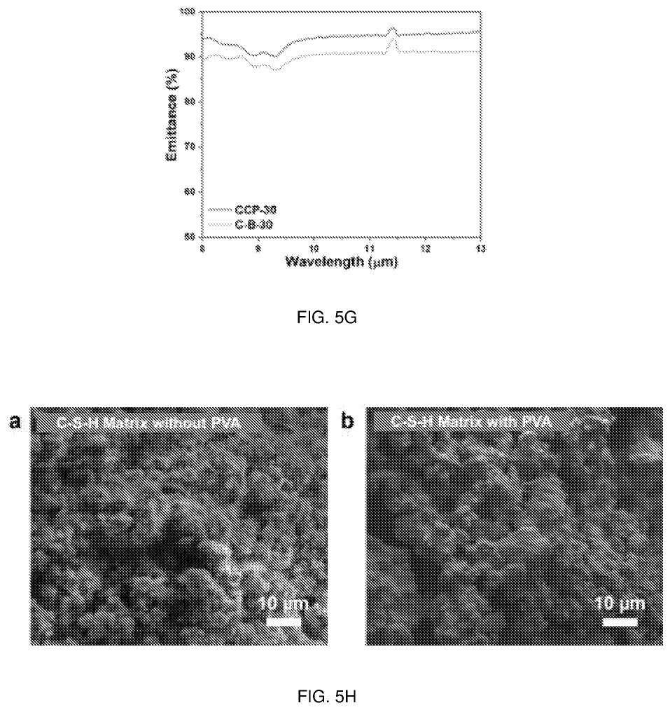

FIG. 4A shows the SEM (scanning electron microscope) image of CCP-30 prepared from Example 1. The SEM image shows C—S—H porous structure with an average pore diameter of about 1 μm and surficial bonded nanoparticles with average diameter of about 350 nm). Due to the in-situ reaction between the cementitious material and water, the CCP-30 exhibits a spontaneously and uniformly formed porous structure. It is clearly shown that additives are fixed on porous wall through strong chemical bonding, allowing efficient water storage within the porous structure. Due to the similar nature with constructional material, CCP-30 formed homogeneous interface with the commercial cement substrate, resulting in strong adhesion that enhances its original robustness (see FIG. 4B). Based on optical property engineering, the inventors successfully endowed the cementitious cooling paint a high solar reflectance (see FIG. 5A) through penetrating nanoparticles with selected size (in the range of about 300 nm to 400 nm), preventing most of the direct solar heating effect through strong Mie scattering.

Scattering efficiency on both pore/air/water and particle/air/water interfaces were evaluated by FDTD simulations. Standard optical indexes (n. k) of components were applied. Scattering cross section of subjects (surrounded with air/water) were calculated and considered to be scattering efficiency after division of cross-section length with total-field scattered-field (TFSF) and perfect matching layer (PML) boundary conditions.

FIG. 5B shows that selected barium sulfate (BaSO₄) possesses strong Mie scattering effect (darker shade) from 300-1500 nm, in which about 90% of solar energy lies. Particle with diameter about 350 nm shows broadest scattering efficiency along solar spectrum, where its intensive scattering effect mainly lies in high solar energy band (300-1500 nm accounts for more than 90% solar energy), manifesting the suitability as solar scattering agent.

Barium sulfate (BaSO₄) shows negligible absorbance in UV range, rejecting at least 4% more solar heating and realizing UV resistive feature. Not only nanoparticle, porous structure of CCP also contributes to solar reflectance at dry state, where dramatic Mie scattering happens at boundaries due to comparable wavelength pore size as well as refractive index difference between matrix and air (FIG. 5C). With synergic scattering from pores and nanoparticles, CCP possesses about 93% solar reflectance at dry state (FIG. 5A).

It is reported that reflection of porous structure falls down by filling with liquid, where the minimized refractive index at pore boundaries leads to weaker scattering effect. As shown in FIG. 5C, scattering efficiency of CCP porous structure dramatically drops upon wetting, while the overall solar reflectance in non-water absorptive range (300 -1300 nm) remains very high compared to previously reported reversible porous structure (FIG. 5A). The stable optical performance originates from Mie scattering of nanoparticles, which shows comparable scattering efficiency within water and air (FIG. 5D). Since nanoparticles are attached on porous matrix, the increased doping level would result in larger surficial occupation ratio, thus leading to minimized scattering change. Since C—S—H matrix roles as skeleton to provide mechanical stability, over addition of nanoparticles will result in weak matrix connection, thus poor mechanical performance. It was found that CCP-30 exhibits only less than 2% optical variation within non-water absorptive range while maintaining good mechanical performance. Though minimized pore scattering and water intrinsic NIR absorbance leads to lowered reflectance from 1300 nm to 2500 nm (FIG. 5E), only less than 3% of solar energy is introduced on accounting of energy distribution. Accordingly, porous CCP-30 exhibits ultralow optical variation (less than 5%, FIG. 5F) upon state changing while maintaining robust structure during water cycle, which is successful solution to the paradox between optical performance and water accumulation in single porous panel. Meanwhile, CCP-30 exhibits about 94% LWIR emittance contributing from intrinsic vibration of —SO₄ and —OH, which is obviously higher than non-additive ones (FIG. 5G) and originates from polymer wrapping on matrix surface (FIG. 5H).

### Example 4

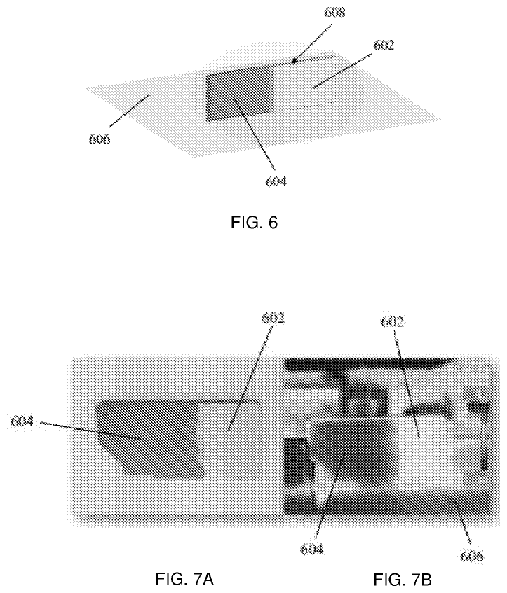

FIG. 6 presents a schematic testing condition of a prepared sample for sidewall application. Cementitious cooling paint 602 was brushed homogeneously on half surface of a concrete brick 604, placed on a concrete block 606 directly under intensive sunlight 608 for temperature monitoring.

A field test was carried out using a calibrated IR camera to monitor the near-static state temperature difference. FIG. 7A shows an optical image of the prepared sample, where apparent color difference exists between the normal brick and a portion of the brick that was coated with the cementitious cooling paint of present disclosure. The cementitious cooling paint is white in colour and this is rationally designed so that it has high solar reflectance (about 85%) but not too white to cause light pollution under direct sunlight. This property is suitable for application onto a construction sidewall. The IR image as shown in FIG. 7B clearly shows a temperature contrast after 2 hours stabilization under strong sunlight, where a −6° C. temperature difference was observed between the left (bare surface of the concrete brick) part and the right (cooling paint-coated surface of the brick) part of the brick.

### Example 5—Cooling Performance

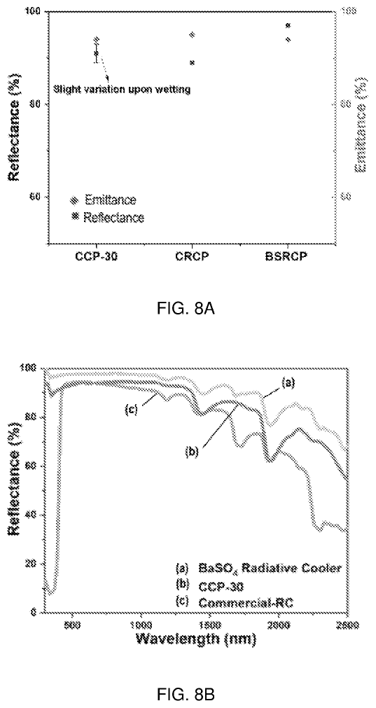

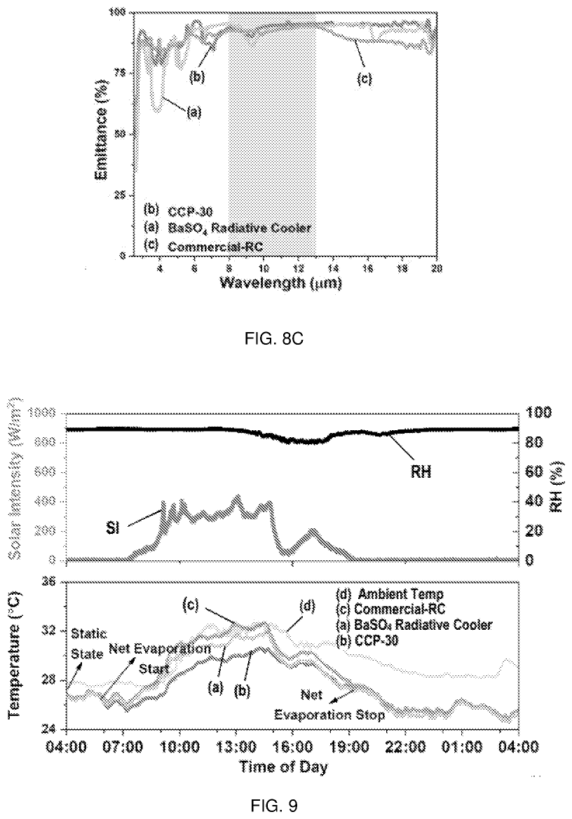

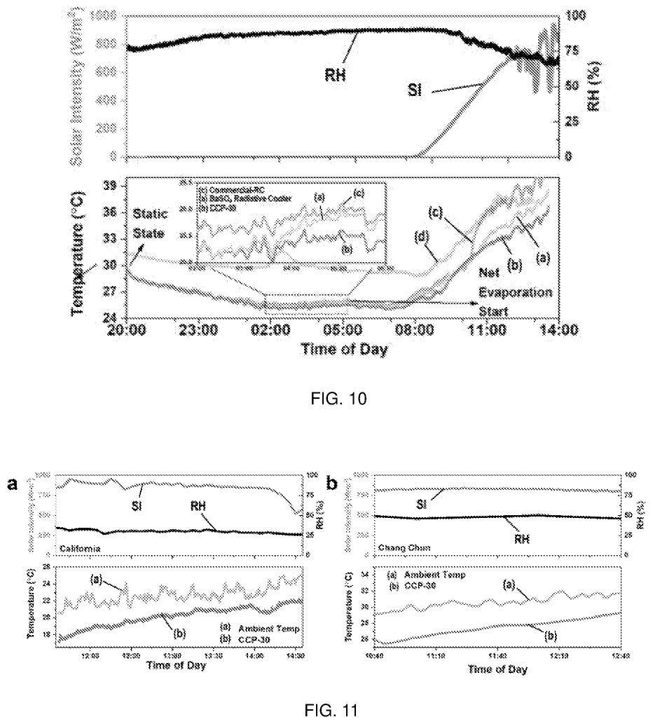

Outdoor tests were conducted to evaluate the cooling performance of CCP-30 sample. Surficial cooling test was first explored among CCP-30, commercial radiative cooler (Commercial-RC Paint: Nippon Cool-Tech®) and reported highly reflective BaSO₄ radiative cooler (BSRCP), where optical features of the three samples are shown in FIGS. 8A, 8B and 8C. In a typical cloudy day with about 90% relative humidity (RH) in Singapore, CCP-30 shows lowest temperature, which is about 2.5° C. cooler than the air under about 350 W/m² sunlight FIG. 9. Theoretical calculation proved that radiative cooling performance in Singapore at daytime is mainly dominated by the solar reflectance. The obvious lower temperature as well as slower temperature increasement of CCP-30 than BaSO₄ radiative cooler indicate the effectiveness of evaporative cooling feature. While high RH hinders radiative cooling power of both, the addition of evaporative cooling power triggered by unsaturated vapor pressure leads to lower temperature. Simultaneously, slowest temperature increasement along sunrise manifesting the effectiveness vapor gathering. Moreover, the net evaporation started when CCP-30 has lower temperature compared to other coolers at night-time, while it stops at about 7 μm when all samples kept at the same temperature without sunlight. This indicates a day-long evaporative duration on cloudy day. Negligible heating effect by hygroscopic process was revealed by the comparable temperature at night (before net evaporation starting and after stopping). Privileged by negligible swelling nature of the robust porous matrix of the cementitious cooling paint, slow hygroscopicity is applicable without worries on structural change during wetting/drying process, thus preventing unwanted adhesion issue. Similarly, CCP-30 exhibits lowest temperature under rising sunlight (at about 10 am) and kept at about 3° C. cooler than air after long night-time (FIG. 10). The better cooling performance than higher reflective paint could be attributed to evaporative cooling feature. Strikingly, lower temperature exhibited by CCP-30 proves that integrating evaporative feature into paint realized better cooling performance with lower solar reflectance, which is suitable for sidewall application as visual and thermal comfort are always concerned. Meanwhile, after water exhaustion around 7 pm, all coolers were kept at same temperatures while CCP-30 gradually became lower from 4 am (inset plots of FIG. 10). This manifests the starting of net evaporation after water accumulation process and worked for about 9 hours (till the end of experiment). Beyond tropics, CCP-30 performs stable sub-ambient cooling performance in different climate zones (California and Changchun, FIG. 11), indicating its universal cooling potential. In summary, CCP-30 serves as good radiative cooler while it exhibits an add-on feature as evaporative cooler enabled by self-motivated water cycling without mechanical deformation.

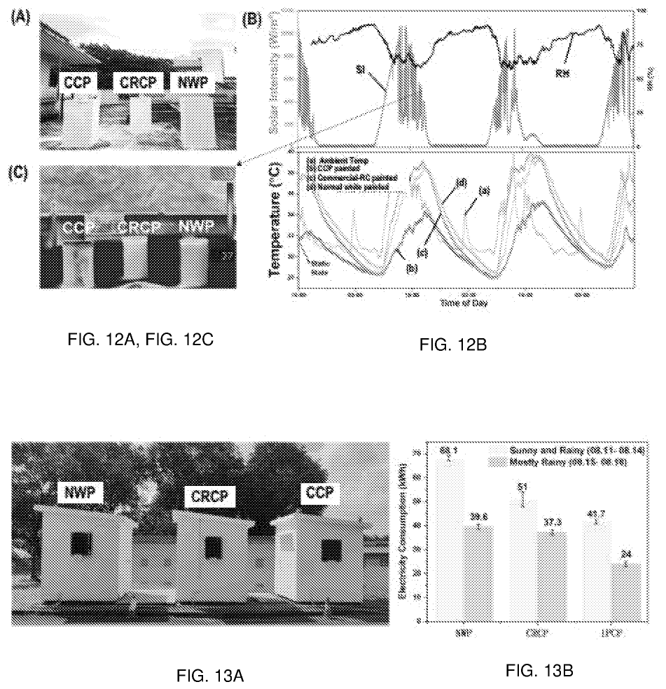

Besides surface cooling, indoor temperature reduction and electricity saving are more straightforward to evaluate the performance of cooling paint. Long-term scalable test was conducted on three demo houses (Dimension: 50 cmL: 40 cmW: 70 cmH, wall thickness about 10 cm) constructing by industrial concrete blocks. Two commercial paints [normal white paint (NWP): Seamaster White Coat-7000N® and commercial-RC (CRCP): Nippon Cool-Tech®] were coated three times to ensure optical uniformity. CCP-30 was fully coated without additional binding layer, showing a matt white surface (FIG. 12A). The delayed temperature peaks compared to air and sunlight, which caused by heat capacity and low thermal conductivity of concrete block, confirm the monitoring of inner house temperature (FIG. 12B). Obviously, CCP-30 coated house exhibits the lowest temperature all the time, which is more than 4.5° C. cooler than other houses and up to about 7° C. cooler than air, manifesting excellent passive cooling performance under tropical climate. Moreover, the surface temperature by IR images at about 4 pm (FIG. 12C) were compared as arrowed. The average surface temperature difference between CCP-30 and the other two paints is about 2° C., where the inner temperature difference remains more than 4° C. for several hours till night, indicating great thermal resistive behavior of CCP-30. The cooling difference between inner and exterior directly reveals the effective minimization of heat accumulation by the add-on evaporative cooling feature. Moreover, the contrastive temperature profile revealed by IR image proves the effectiveness of integrative passive cooler on façade application.

To further justify cooling outcome, energy saving, as well as the weather adaptivity of CCP-30, three painted livable size concrete houses with air-con system and independent electricity meters were built for comparison (Optical image shown in FIG. 13A). The houses have about 15 cm wall thickness with isolative layer inside, which resembles the real construction protocol. Target indoor temperature were set to 26° C., which is commonly accepted to be a comfortable value. Two sets of 3-day experiment were conducted to evaluate the energy consumption under different weathers. During typical alternated sunny and rainy days, CCP-30 shows about 20% to 40% energy saving comparing to commercial paints, which are contributed by both radiative and evaporative cooling. Strikingly, CCP-30 shows stable energy saving of about 40% during continuous rainy days compared to both CRCP and NWP. While similar electricity consumptions between two commercial paints reveals negligible contribution difference from solar reflection and radiative cooling, obvious energy saving of CCP-30 mainly comes from evaporative cooling even though under high RH. In summary, CCP-30 serves as integrated passive cooler with strong adaptivity to different weather conditions attributing to the stable optical performance and robustness porous structure.

### Example 6

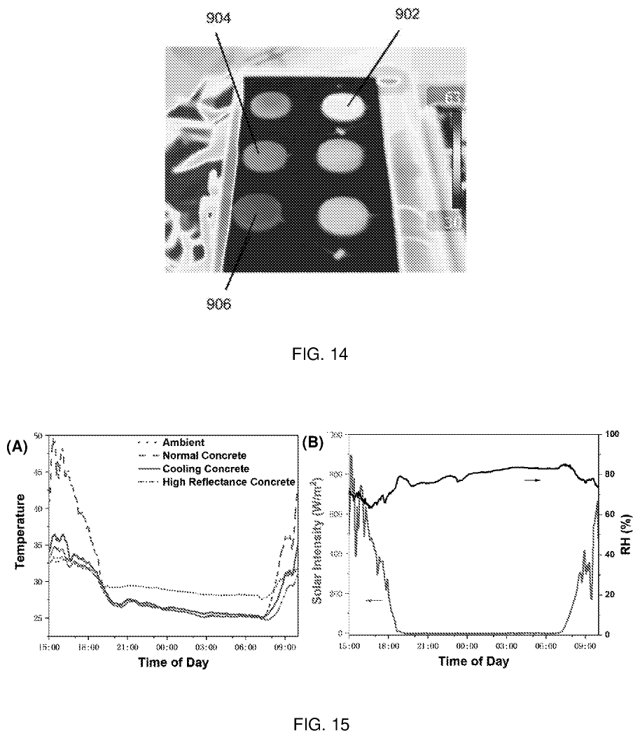

Cementitious cooling construction material was evaluated in a field test. FIG. 14 shows a setup with mainly three types of samples: normal concrete 902; cooling concrete 904 coated with varied component ratios; and a high-reflectance concrete 906. The cooling concrete 904 has proper solar reflectivity especially in visible range, which is designed for prevention of light pollution. For highly reflective concrete 906, it backscatters most of the solar energy with a neutral white color, resulting in concerns of light pollution under strong sunlight. As shown in FIG. 15, the cementitious cooling construction material of the present disclosure achieved a considerable low temperature similar to the highly reflective one under 1000 W/m² sunlight. This is attributed to the integrated evaporative and radiative cooling.

The results obtained from the field test, as shown in FIG. 15 and FIG. 16 indicate a durable cooling performance of the cementitious cooling construction material of the present disclosure. At nighttime, the cooling concrete absorbs water from ambient air, which is supposed to increase its temperature. In contrast, the close temperatures of the three types of samples at nighttime (see FIG. 15) indicates that the gradual water absorption/capture process generates negligible heat, which is very important to avoid temperature peak. At daytime, the cooling concrete shows up to −12° C. lower temperature than a normal concrete, and similar temperature to a highly reflective concrete yet without glare/light pollution issue, as shown in FIG. 16. The sustainable cooling performance at daytime suggests sufficient water replenishment at nighttime for the cooling concrete coated with the cementitious cooling paint of the present disclosure.

### Example 7—Robustness Test

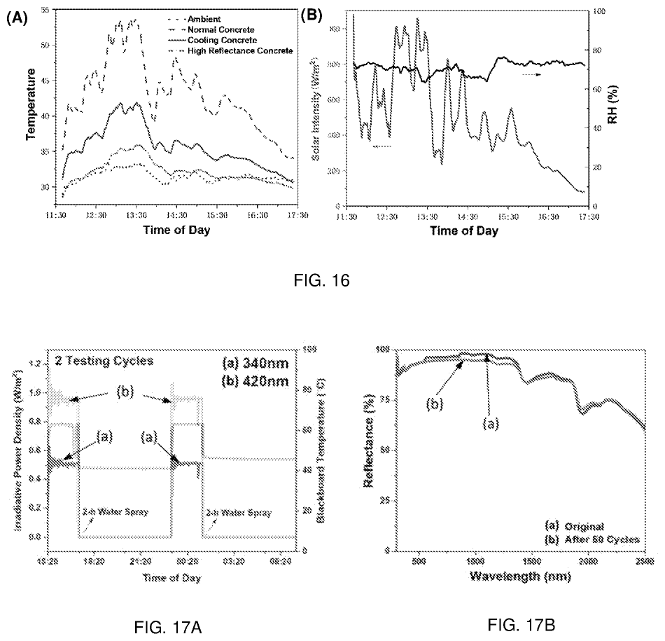

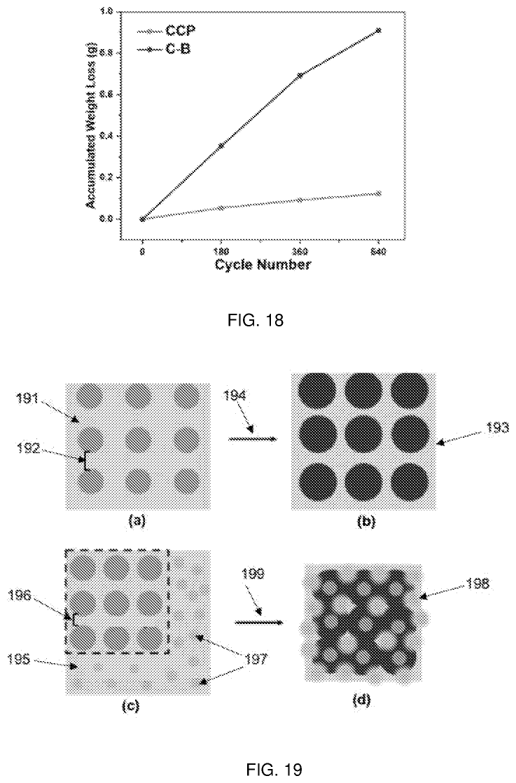

For long-term outdoor cooling, solar degradation of paints always brings irreversible effect, especially for products using organic binder. In this example, a robustness test was conducted within an environmental exposure chamber to evaluate its optical performance. The simulated sunshining, raining and nighttime whether conditions were programmed as shown in FIG. 17A, where 50-cycle was set for the degradation test. The results as shown in FIG. 17B suggest that the cementitious cooling paint of the present disclosure exhibits stable optical performance, revealing an excellent anti-solar degradation feature for outdoor usage. An abrasion test was also conducted to prove the stability of the formed porous structure. The results obtained were compared with a dense commercial paint. FIG. 18 shows that the porous cementitious cooling paint of the present disclosure possesses an even higher robustness as revealed by the anti-friction feature, which is mainly attributed to the formation of C—S—H gel matrix.

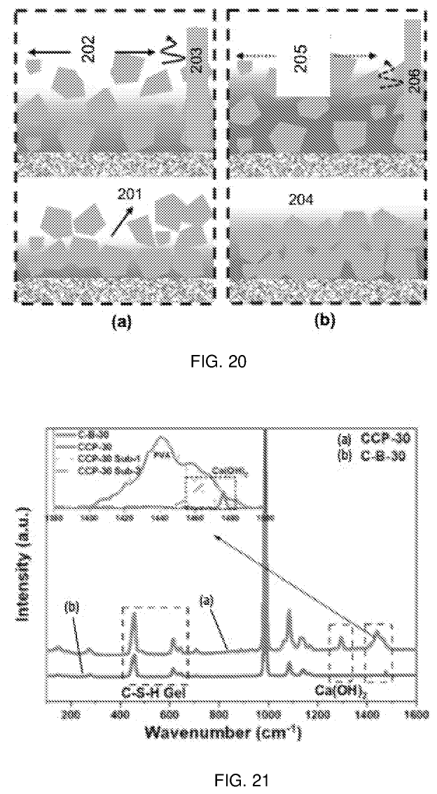

The CCP-30 structure arises from a hydration process between cement powder and water, where C—S—H gel forms to provide the robustness. In this process, water to cement ratio (W/C ratio) plays significant role. Normally, W/C ratio is positive to porosity of C—S—H matrix and is usually kept within 0.4-1.0 to maintain good mechanical robustness as well as mortar workability. While homogeneous dispersion of nanoparticle leads to better optical performance, increasement of water is essential as both reactant and dispersant, thus leading to a higher W/C ratio. With same W/C ratio (of about 2), chalking phenomenon is observed in pure cement, while CCP-30 shows negligible weight loss even after severe abrasion. This attributes to the insufficient compaction between cement powder during reaction process (FIG. 19), thus limiting connections between C—S—H particles during hydration. This is further confirmed by the obvious boundaries of hydrated C—S—Hs, indicating the poor connection between each other. Relatively, BaSO₄ nanoparticles formed weak hydrogen bond with surrounding water molecule (FIG. 19), trapping partial water to reduce effective free water ratio, which leads to the compaction of cement powders during hydration. The yield stress (YS) of fresh CCP-30 precursor manifests an effective W/C from 0.38 to 0.47 compared to reported results, proving not only a more compactable structure but also a suitable workability like normal mortar paste. Privileged by viscoelastic property, thickness of CCP-30 is tunable (up to 2.28 mm) with one-time painting procedure, which enables sufficient water storage volume as well as potential aesthetic purposes like patterning. However, solely addition of nanoparticles is not sufficient to obtain a robust porous structure, where cracks happen during early hydration period. Noted that CCP-30 slurry continuously loses water once painted, the cracks mainly attribute to the capillary pressure induced plastic shrinkage, which is determined by the water loss speed (FIG. 20). Contrastively, uniform structure is derived with about 2% wt addition of PVA and LiCl, where stronger hydrogen bonding network and hygroscopic effect help to keep moisture and thus leads to negligible plastic shrinkage (FIG. 20). Other than chalking and cracking issues, anti-abrasion behavior was also investigated to evaluate surface robustness. Negligible weight loss of CCP-30 under severe abrasion (1.25 kg load with H-10 roughness wheel) during 540 cycles undoubtedly proves strong mechanical performance. Since the robustness mainly originates from expansion and connection of hydrated phase, the weaker surface of C-B-30 indicates lower density of C—S—H connection, which is a low degree of hydration in other words.

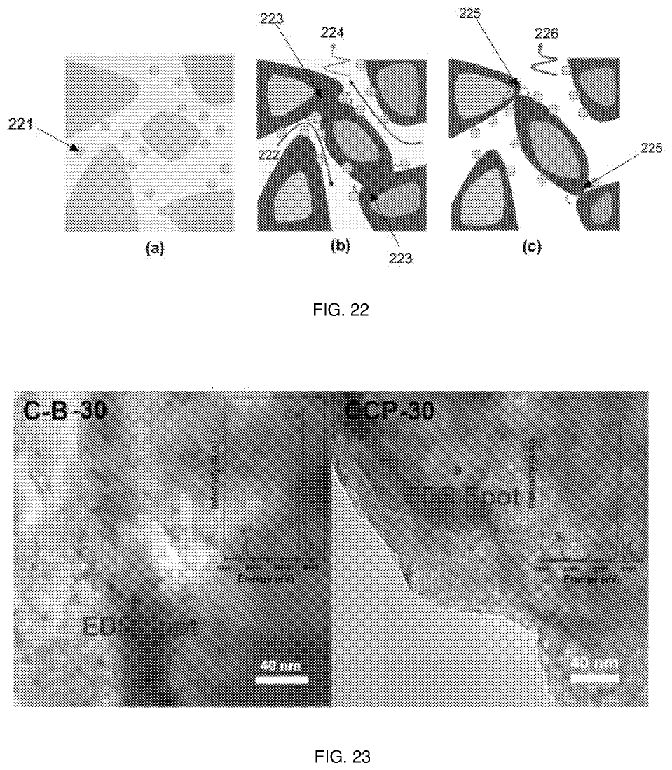

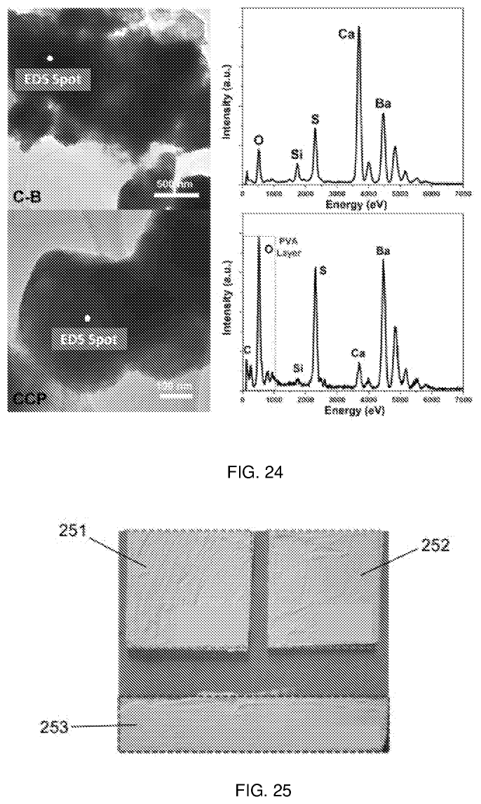

Raman spectrum confirms the formation of C—S—H matrix in both samples, while different peaks of about 1500 cm⁻¹ reveal contrastive generation of calcium hydroxide, corresponding to a lower degree of hydration in C-B-30. (FIG. 21). Slower water loss induced by polymeric additives and simultaneous vapor capturing by hydroscopic effect promise cement powders (in CCP-30) to undergo longer hydration to achieve sufficient expansion and connect with each other, while cement powders in non-additive precursor (C-B) suffer from insufficient reactant (water) during days long hydration process, resulting in poor connection and thus a weaker matrix (FIG. 22). Notably, CCP-30 initial curing time (about 2-3 h, Vicat Needle Method according to C191-08) resembles that of commercial paints, while the long hydration reaction afterwards continuously strengthens the robustness to higher level. Meanwhile, the C—S—H matrix in CCP-30 possesses more homogenous crystalline structure than that of C-B-30, where the EDS results showing contrastive Ca-Si ratios, further indicating the difference of hydration degree (FIG. 23). It is clear that nanoparticles strictly attached on porous matrix through strong hydrogen bonding interaction, where PVA and LiCl are uniformly distributed on matrix surface (FIG. 24). With mentioned optimizations, the CCP-30 exhibits uniform porous structure and excellent robustness with anti-swelling feature after spontaneous hydration.

### Example 8

For scalable application of paint product, the adhesivity, durability as well as aesthetic behavior play important roles. The cement-based nature of CCP-30 determines the excellent adhesivity on most widely adopted constructional material-concrete (FIG. 25), where the SEM image and elemental map show obvious interface between CCP-30 and the dense concrete substrate by Ba and S elements (FIG. 4B). Wide distribution of Ca indicates homogeneous interface, which may attribute to the formation of C—S—H with un-hydrated phase in substrate. Except for bare construction surface, repainting projects are based on a layer of primer/sealer for both protection and better adhesion. Thus, the adhesivity between CCP-30 and industrial wall sealer was evaluated. As shown in FIG. 25, CCP-30 adheres tightly on both oil-based wall sealer surface 251 and water-based wall sealer surface 252 without cracking and falling-off after curing (vertically painted), which is attribute to abundant Si—O and strong hydrogen bonding interactions. The good adhesivity remains after direct exposure to outdoor for 90 days, promising long-term stability as well as broad surface applications. Both as water-based paint, NWP cracks at edge of two concrete blocks due to undulate morphology and small amount of water loss into concrete structure, while CCP-30 cured homogeneously without obvious edge appearance. This is because fast water loss in PVC paint leads to inhomogeneous particle dispersion and crosslinking of binder, thus strain induced cracking happens. On the contrary, abundant water fixed by strong hydrogen bonding network (polymer induced) in CCP-30 ensures less water loss into substrate, thus maintaining a stable structure. Correspondingly, CCP-30 exhibits not only better structural stability but also defects repairing function on concrete surface.

Water cycle effect on porous structure is mostly considered problem to current state since reported passive coolers are mainly based on hydrogels which exhibit swelling and adhesive issues. A test was carried out and it was shown that CCP-30 remains adhesive upon 100 water cycles without any structural change, which eliminates the concern on swelling and promises stable integrated passive cooling feature upon varied daily weathers.

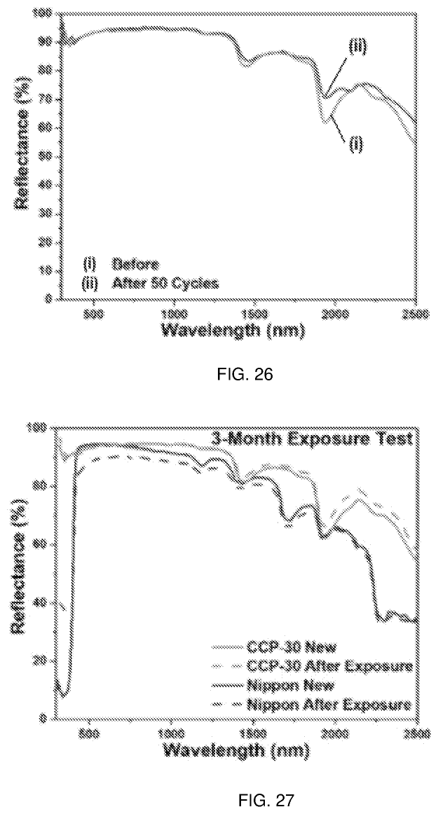

Anti-weathering test was conducted to evaluate the optical stability against environment. Weather-simulated chamber was adopted to alternatively repeat sunlight, raining and dark time for about 50 cycles (500 hours, parameters shown in FIG. 17A) to trigger the surficial degradation, while CCP-30 reveals negligible optical change (FIG. 26). Moreover, 3-month outdoor exposure (2023.03.03-2023.06.03, Singapore) was conducted for comparison between commercial-RC and CCP-30 (FIG. 27). Obvious reflectivity reduction is observed on commercial-RC while CCP-30 remains stable. In fact, the UV-absorbing nature of commercial-RC would result in polymer degradation under synergic effects with wet air, intensive sunlight and high temperature, while the UV-resistive nature and robust C—S—H matrix endow CCP-30 good optical stability. Moreover, hydroscopic effect introduces thin water film on CCP surficial pore matrix, minimizing electrostatic charge accumulation and allowing transportation-off of particles/dusts.

Apart from environmental resistance, anti-abrasion test was conducted to evaluate surficial mechanical robustness. To resemble severe friction that would happen in daily life, hard abrader (H-10) with 1.25 kg load was adopted. The porous CCP-30 exhibits about 70% lower weight loss after 540 cycles comparing to dense commercial-RC, thanks to the rigidity provided by C—S—H gel, where contrastive surficial evidence left.

In summary, durable, and robust structure of CCP-30 promises long-term stable outdoor usage.

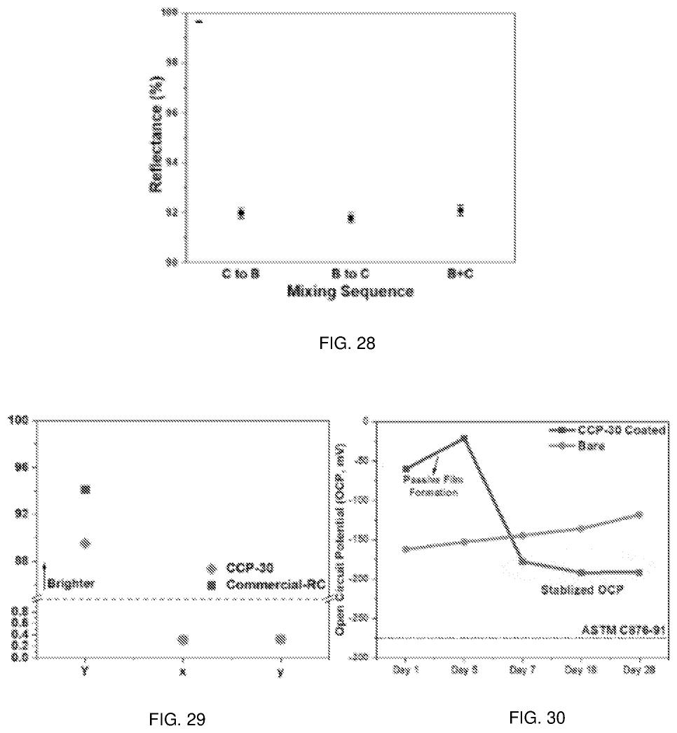

The two solid phases exhibit contrastive size (cement particle size 3-30 μm, nanoparticle about 350 nm) and interact with water differently. Specifically, water works as dispersant to nanoparticles while it reacts with cement particles. Obvious sequential side-effect will lead to add-on procedure for precursor preparation, resulting in higher time/cost consumption. Thus, effect of solid phase adding sequence is investigated to further evaluate the applicability. As shown in FIG. 28, the comparable reflectance of different adding sequences manifests the feasibility by all-in-one method, matching with standard utilization procedure of cement-based products.

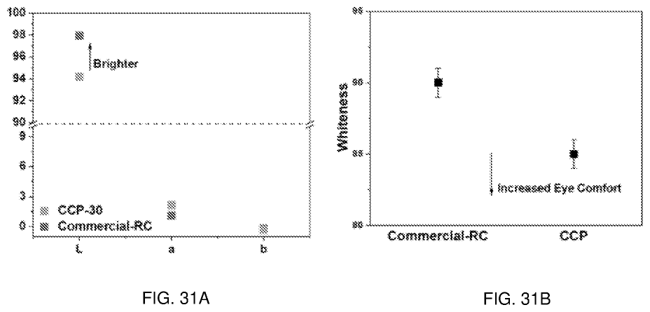

From the mechanism of radiative cooling, thermal emission facing to sky (rooftop application) is favored while sidewall-placing narrows the effective entrance angle into atmospheric window as well as receiving more emitted energy from surroundings. Relatively, the non-directional evaporative behavior directly consumes incident energy at surface and lowers down inner energy triggered by unsaturated vapor pressure (RH less than 100%), ensuring the suitability for sidewall application. However, the high whiteness is always a concern under sunlight which causes visual discomfort. Thus, the coloring performance of CCP-30 was comprehensively evaluated by comparing CCP-30 to the public-utilized commercial-RC (Nippon Cool-Tech®) on public housing facades based on different criteria. The Yxy color space (CIE 1931, FIG. 29) confirms comparable dominant wavelength (x) and saturation (y) between two coatings, while CCP-30 exhibits a lower brightness (Y). Moreover, L*a*b space (CIE 1976, FIG. 31A) shows similar result that both paints exhibit comparable color (a* for red-green, b* for yellow-blue) but different whiteness (L* for white-black). Consistently, the lower whiteness proves that CCP-30 appears dimmer, which could be attributed to the matt surface resulting from the porous structure. Accordingly, the CCP-30 possesses lower whiteness but a better passive cooling performance than both commercial-RC and high reflective radiative cooler (whiteness about 94, FIG. 31B), providing insights on designing effective passive cooling paint with proper albedo for building facades.

The corrosion induction of CCP-30 was also investigated. Since embedded LiCl works for water accumulation out of raining time, the movement into reinforced concrete (R-Con) is considered as potential corrosion source. Three-electrode method was adopted to evaluate the corrosion situation within a whole month according to ASTM C876-91, where CCP-30 is directly coated on a R-Con cubic and half-immersed in water (FIG. 30). Obviously, passive fill formed at initial curing stage within first five days, where the OCP (Open Circuit Potential) starts to increase. After stabilization, part of Cl⁻ diffuses into R-Con along capillary diffusion with water and leads to OCP reduction. It is worth noting that a stabilized OCP around −200 mV was observed, which is considered a safe and non-corrosive situation of R-Con (ASTM C876-91 standard indicated by dotted line), revealing its suitability for bare constructions.

Although embodiments of the invention have been shown and described, the invention is not limited to the described embodiments. Instead, it would be appreciated by those skilled in the art that various modifications and variations can be made to the embodiments of the invention without departing from the scope of the invention, the scoop of which is set forth in the following claims.

1. A cementitious cooling paint comprising:
a composite cement;
a structural filler;
a water-absorbing polymer;
a water capture material; and
water;
wherein
the water to composite cement ratio is from 0.4 to 1.2 by mass;
the composite cement to structural filler ratio is from 0.4 to 0.7 by mass;
the composite cement to water-absorbing polymer ratio is from 0.01 to 0.03 by mass; and
the composite cement to water capture material ratio is from 0.05 to 0.3 by mass; and
wherein the cementitious cooling paint exhibits dual passive cooling mechanisms including radiative cooling and evaporative cooling.

2. The cementitious cooling paint according to claim 1, further comprising: a dispersant, wherein the composite cement to dispersant ratio is from 20 to 50 by mass.

3. The cementitious cooling paint according to claim 1, wherein the composite cement is at least one selected from the group consisting of various types and grades of Portland cement and geopolymer cement.

4. The cementitious cooling paint according to claim 1, wherein the structural filler is at least one selected from the group consisting of silicon dioxide (SiO₂), barium sulfate (BaSO₄), calcium carbonate (CaCO₃), zinc oxide (ZnO), aluminum oxide (Al₂O₃), zirconium dioxide (ZrO₂), titanium dioxide (TiO₂), iron(III) oxide (Fe₂O₃), hydrated goethite (α-FeOOH) and Prussian Blue.

5. The cementitious cooling paint according to claim 1 or 4, wherein the structural filler comprises nanoparticles having an average particle size ranging from 0.3 μm to 2 μm.

6. The cementitious cooling paint according to claim 1, wherein the water-absorbing polymer is at least one selected from the group consisting of sodium poly(acrylate), sodium carboxymethyl cellulose and sodium alginate, polyvinyl alcohol, hydroxypropyl methylcellulose and carboxymethyl cellulose.

7. The cementitious cooling paint according to claim 1, wherein the water capture material is at least one selected from the group consisting of deliquescent salt such as lithium chloride (LiCI) and calcium chloride (CaCl₂).

8. The cementitious cooling paint according to claim 2, wherein the dispersant is at least one selected from the group consisting of sodium polyacrylic and superplasticizer such as sulfonated naphthalene formaldehyde condensate, sulfonated melamine formaldehyde condensate, acetone formaldehyde condensate and polycarboxylates ethers.

9. A cementitious cooling construction material comprising:
a composite cement;
a structural filler;
a water-absorbing polymer;
a water capture material;
a dispersant; and
water; wherein
the water to the composite cement ratio is from 0.5 to 1.5 by mass.
the composite cement to structural filler ratio is from 0.4 to 0.7 by mass;
the composite cement to water-absorbing polymer ratio is from 0.01 to 0.03 by mass;
the composite cement to water capture material ratio is from 0.05 to 0.3 by mass; and
the composite cement to dispersant ratio is from 8 to 15; and
wherein the cementitious cooling construction material exhibits dual passive cooling mechanisms including radiative cooling and evaporative cooling.

10. The cementitious cooling construction material according to claim 9, further comprising alkaline water for hydrating the cementitious cooling construction material and for preventing the cementitious cooling construction material from cracking.

11. The cementitious cooling construction material according to claim 9, wherein the composite cement is at least one selected from the group consisting of various types and grades of Portland cement and geopolymer cement.

12. The cementitious cooling construction material according to claim 9, wherein the structural filler is at least one selected from the group consisting of silicon dioxide (SiO₂), barium sulfate (BaSO₄), calcium carbonate (CaCO₃), zinc oxide (ZnO), aluminum oxide (Al₂O₃), zirconium dioxide (ZrO₂), titanium dioxide (TiO₂), iron(III) oxide (Fe₂O₃), hydrated goethite (α-FeOOH) and Prussian Blue.

13. The cementitious cooling construction material according to claim 9 or 12, wherein the structural filler comprises nanoparticles having an average particle size ranging from 0.3 μm to 2 μm.

14. The cementitious cooling construction material according to claim 9, wherein the water-absorbing polymer is at least one selected from the group consisting of sodium poly(acrylate), sodium carboxymethyl cellulose and sodium alginate, polyvinyl alcohol, hydroxypropyl methylcellulose and carboxymethyl cellulose.

15. The cementitious cooling construction material according to claim 9, wherein the water capture material is at least one selected from the group consisting of deliquescent salt such as lithium chloride (LiCI) and calcium chloride (CaCl₂).

16. The cementitious cooling construction material according to claim 9, wherein the dispersant is at least one selected from the group consisting of sodium polyacrylic and superplasticizer such as sulfonated naphthalene formaldehyde condensate, sulfonated melamine formaldehyde condensate, acetone formaldehyde condensate and polycarboxylates ethers.

17. The cementitious cooling construction material according to claim 10, wherein the cementitious cooling construction material has a viscosity suitable for fabricating cement-based building product selected from cooling tile, cooling brick, cooling concrete, cooling concrete block, cooling concrete slab and cooling cement wall.

18. A cement-based building product comprising a cementitious cooling construction material as defined in claim 9, wherein the cement-based building product is one selected from cooling tile, cooling brick, cooling concrete, cooling concrete block, cooling concrete slab and cooling cement wall.

19-28. (canceled)
